(19) United States
(12) Patent Application Publication
(10) Pub. No.: US 2021/0380768 A1
(43) Pub. Date: Dec. 9, 2021

(54) SOLVENT BASED SPRAYABLE STRIPPABLE COATING

(71) Applicant: Berry St.Vil, North Miami Beach, FL (US)

(72) Inventor: Berry St.Vil, North Miami Beach, FL (US)

(21) Appl. No.: 16/893,426

(22) Filed: Jun. 4, 2020

(51) Int. Cl. C08J 5/18; C08K 5/00; C08K 5/11; C08K 5/12; C08K 5/1545; C08K 5/5419; C09D 7/44; C09D 129/04; C09D 101/02; C09D 107/02; C08L 1/02; C08L 7/02; C08L 29/04

(52) U.S. Cl. CPC C08J 5/18; C08K 5/0016; C08K 5/11; C08K 5/12; C08K 5/1545; C08K 5/5419; C08L 2201/06; C09D 129/04; C09D 101/02; C09D 107/02; C08L 1/02; C08L 7/02; C08L 29/04; C09D 7/44

(57) ABSTRACT

The present invention discloses a composition which uses bio-based, biodegradable film formers to provide a durable strippable coating. The coating includes a film former configured to form a continuous film on the substrate. The coating includes a solvent, wherein the solvent is configured to result an easy application of the substance on the substrate. The coating includes one or more additives. The one or more additives include a plasticizer to improve flexibility of the film. The one or more additives include a release agent configured to reduce adhesion of the coating on the substrate. The one or additives a thickener configured for adjusting a viscosity and of the coating.

### FIELD OF THE INVENTION

The present invention is generally related to a strippable solvent based protective coating. The coating can be removed from the underlying surface by peeling when no longer desired. More specifically, the present invention relates to a solvent based strippable coating that is biodegradable.

### BACKGROUND

In many manufacturing environments, treating painted and unpainted surfaces has become an important process that needs to be addressed to finalize many industrial projects. The needs for these treated surfaces can provide for additional protection, and effective treatment of a variety of surfaces that may be exposed to a variety of environmental elements.

Exposure to a variety of different environmental elements has led to prevention of corrosion, rusting, pre-mature fading, and other adverse ecological impacts. In the past various processes have been used for protecting various structures such as galvanizing, powder coating, painting or other chemical or physical adaptation of various substrates and structures. Similarly, many products must be protected during fabrication or assembly by downstream manufacturers. For example, plastic laminates and other materials with high-gloss finishes such as bathroom fixtures and chrome plated or brass surfaces must be protected not only during shipping, but also during installation or assembly into other products.

Accordingly, strippable coatings are widely used in the market place for various applications. In a first application, the strippable coatings are used to mask the underlying surface from undesirable paint or other coatings. Additionally, the strippable coatings are used to protect the underlying surface from scratches, dust etc. In other instances, the strippable coatings can be used to remove micron sized contaminants from optical surfaces. Decontamination of hazardous and radioactive waste from surfaces is also another way that strippable coatings can be utilized. Most of the strippable coatings are based on different film formers dissolved in solvents. They contain different kind of additives like plasticizers, release agents, thickeners, flame retardants, biocides, preservatives etc. Each additive is selected based on the property desired in the final product.

Patent No. US20140018280 discloses a temporary coating for protection of automobiles but the coating of the invention contains film formers that are synthetic and non-biodegradable. Also, the coating of the invention has to be removed by solvent based cleaner thus making the removal process hard and cumbersome.

However, the strippable coatings of the prior art are not biodegradable and thus are not environment friendly. Also, there is an on-going need for improving the properties of strippable coatings, in particular with respect to improved mechanical and chemical properties of one or more coating layers. The present invention discloses a composition which uses bio-based, biodegradable film formers to provide a durable strippable coating. The strippable coating of the present invention dries very fast after application.

### SUMMARY

For the foregoing reasons, there is need for a bio-based, biodegradable strippable coating composition for protecting a surface of a substrate. The coating can be removed from the underlying surface by peeling. In some aspects, the present invention discloses a composition which uses bio-based, biodegradable film formers to provide a durable strippable coating. The strippable coating of the present invention dries very fast after application.

In some aspects, a process for protecting a surface of a substrate comprising spraying a substance to the surface of the substrate is disclosed. The substance includes a film former configured to form a continuous film on the substrate. The substance includes a solvent, wherein the solvent is configured to result an easy application of the substance on the substrate. The substance includes one or more additives. The one or more additives include a plasticizer to improve flexibility of the film. The one or more additives include a release agent configured to reduce adhesion of the substance coating the substrate. The one or additives a thickener configured for adjusting a viscosity of the substance.

In one embodiment, the film formers are selected from one or more of biodegradable film formers comprising poly vinyl alcohol, hydroxy propyl methyl cellulose, cellulose acetate butyrate, ethyl cellulose, natural rubber latex.

In one embodiment, the solvent is selected from a list of nontoxic solvents comprising water, alcohols, acetone, ethyl acetate, glycol esters, glycol ethers.

In one embodiment, the non-toxic solvents are configured to evaporate resulting in fast drying and a forming of a film. In one embodiment, the plasticizer is selected from a group of one or more sucrose acetate isobutyrate, propylene glycol, glycerin, glycerol, dioctyladipate, diisononylphthalate, and epoxidized soybean oil.

In one embodiment, the release agents are selected from a group of one or more of non-ionic surfactants, fluoro-surfactants, siloxane-based surfactants, fatty diketene, wax emulsion, and soy lecithin.

In one embodiment, the thickener is selected from a group of one or more of fumed silica, xanthan gum, and polysaccharides.

In one embodiment, the coating composition comprises of 60% to 80% of solvents, 8% to 20% of bio-based biodegradable film formers, 5% to 12% of plasticizers and 0.5% to 5% of release agents.

In one embodiment, the substrate is one or more of metal, wood,-plastic, or stone.

In one embodiment, the film former comprises of cellulose acetate butyrate.

In one embodiment, the plasticizer comprises of dioctyladipate, disononyphthalate and sucrose acetate butyrate.

In one embodiment, the plasticizer comprises of sucrose acetate isobutyrate.

In one embodiment, the solvent comprises of Ethyl Alcohol, Isopropyl Alcohol, Acetone, Ethyl Acetate, and Butyl Acetate. In one embodiment, the release agent comprises of polyether modified siloxane.

In one embodiment the dry to touch time of coating of the invention is less than 5 minutes. More preferably the dry to touch time of coating of the invention is less than 2 minutes.

“Dry-to-touch time is the length of time measured from a coating's application to the drying stage where the coating has hardened enough so that it can be touched lightly without any adhering to the finger.”

This summary is provided merely for purposes of summarizing some example embodiments, so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

Disclosed herein are embodiments of a solvent based strippable coating composition which comprises of bio-based, biodegradable film formers, solvents, plasticizers and release agents. This description includes drawings, wherein:

FIG. 1 depicts an exemplary table including a formulation of cellulose acetate butyrate solvent based sprayable strippable coating, in accordance with an example; and

FIG. 2 depicts an exemplary table of ingredients of a formulation of cellulose acetate butyrate solvent, in accordance with an example.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention.

Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required.

The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein. The invention may be embodied in other specific forms without departing from the spirit of essential characteristics thereof.

The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein. The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The present invention discloses a composition which uses bio-based, biodegradable film formers to provide a durable strippable coating. The coating composition comprises of biobased biodegradable film former configured to form a continuous film on the substrate. The coating includes a solvent, wherein the solvent is configured to result an easy application of the coating on the substrate. The coating includes one or more additives. The one or more additives include a plasticizer to improve flexibility of the film. The one or more additives include a release agent configured to reduce adhesion of the substance coating the substrate. The one or additives a thickener configured for adjusting a viscosity of the substance.

The strippable coating comprises of following main ingredients: film formers, solvents, plasticizers and one or more additives like release agents and thickeners.

The film former is configured to form a continuous film on the substrate. The choice of the film former can depend on the properties required in the final product. The film formers used in strippable coatings can be selected from a group of biodegradable film formers comprising one or more of Poly Vinyl Alcohol, Hydroxy Propyl Methyl Cellulose, Cellulose Acetate Butyrate, Ethyl Cellulose, Natural Rubber Latex.

Preferably, the film former used is cellulose acetate butyrate as it is water resistant. Cellulose Acetate Butyrate is commercially available from Eastman Cehmical Company. The most suitable grades that can be used are CAB 531.1 and 553.0.4.

Solvents are used to adjust the viscosity of the coating so that it can be applied easily on the substrate. The selected film former should also be soluble in the chosen solvent. Generally, there are water-based coatings in which water is the solvent and solvent based coating in which other organic solvents are used. It is always preferable that the solvents used in the coating are nontoxic. It is also desired that the solvent evaporates easily so that the coating is fast drying and forms a film in less time. The solvent can be selected from one or more of the following nontoxic solvents: water, alcohols, acetone, and glycol ethers. Preferably most suitable solvents are ethyl acetate and acetone.

A plasticizer is used to improve the flexibility of the material. The plasticizer can be selected from one or more of Sucrose Acetate Isobutyrate, Propylene Glycol, Glycerin, Glycerol, Dioctyladipate, Diisononylphthalate, Epoxidized Soybean oil. Preferably most suitable plasticizer is Sucrose Acetate Isobutyrate. It is commercially available as grade SAIB 100 or SAIB 90 EA from Eastman Chemical Company.

The one or more additives can also comprise of release agents. The release agents are used to reduce adhesion of the coating to the substrate so that it can be easily peeled away. The release agents can be selected from one or more of nonionic surfactants, fluoro-surfactants, siloxane-based surfactants, fatty diketene, wax emulsion, soy lecithin. Preferably most suitable release agent is polyether modified siloxane. The polyether modified silicone is commercially available under grade BYK333 from BYK Chemie Ltd.

The one or more additives can also include a thickener. Thickeners are used for adjusting viscosity of the product and for better dispersion of filler in polymer matrix. The thickeners can be chosen from the group of Fumed Silica, Xanthan Gum, Polysaccharides.

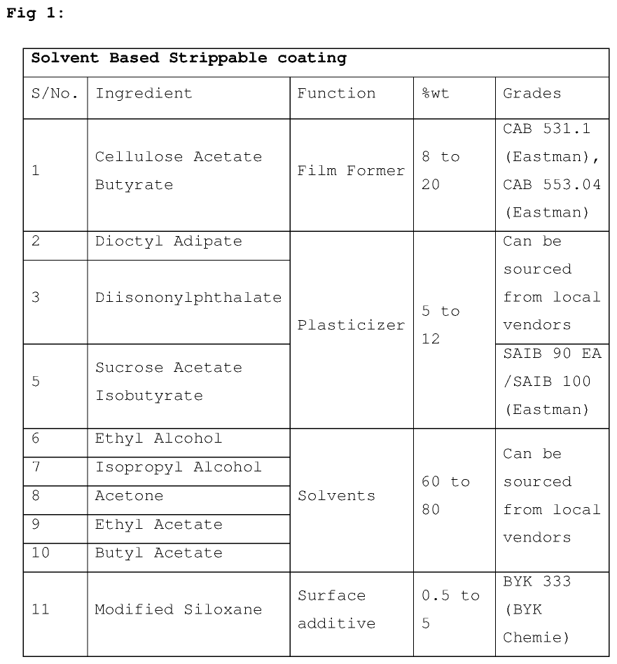

FIG. 1 depicts an exemplary table including a formulation of cellulose acetate butyrate solvent based sprayable strippable coating. Cellulose acetate butyrate solvent based sprayable strippable coating can be a coating that is a solvent based liquid coating of low viscosity. In some examples, and in the preferred embodiment, the solvent can be sprayed in a clear and transparent coating on a substrate. The substrate can be one or more of metal, wood, plastics, or stone.

In one embodiment, the film former can comprise of the ingredient cellulose acetate butyrate at a 8 to 20 Wt %. The plasticizer can comprise of dioctyladipate, diisononylphthalate,and sucrose acetate isobutyrate, with a 5 to 12 Wt %. The solvent can comprise of ingredients including ethyl alcohol, ethyl acetate, butyl acetate, acetone, and isopropyl alcohol with a 60 to 80 Wt %. The solvent ingredients can be sourced from local vendors. Lastly, the surface additive can comprise of polyether modified siloxane with a 0.5 to 5 Wt %.

In one embodiment the dry to touch time of coating of the invention is less than 5 minutes. More preferably the dry to touch time of coating of the invention is less than 2 minutes. “Dry-to-touch time is the length of time measured from a coating's application to the drying stage where the coating has hardened enough so that it can be touched lightly without any adhering to the finger.”

In one embodiment, the thickness of the film is configured to be at least 50 microns for substrate surfaces including glass, steel, metal, plastic, and rough surfaces such as non-porous stone. In the instance of non-porous stone, the thickness of the film can be increased in order to compensate for the rough surface and increase the ease of peeling.

Accordingly, in some embodiments the film of a 50-micron thickness can be formulated to be easily peelable from smooth surfaces. In order to facilitate the peelable consistency from a rough surface, the thickness of the film can be great than or equal to 250 microns.

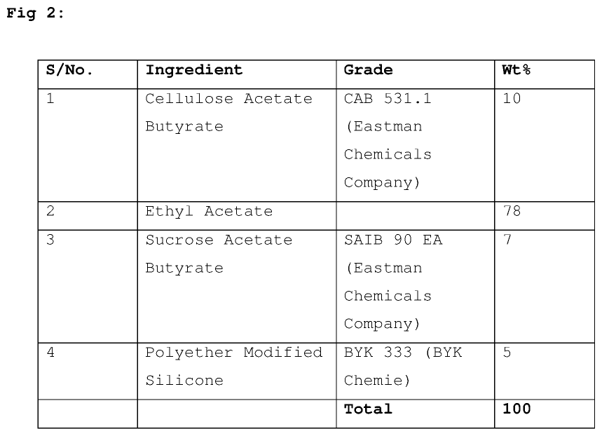

In one example, FIG. 2 depicts an exemplary table of ingredients of a formulation of strippable coating of the invention. In order to achieve the ability to make the formulation sprayable, the formulation in FIG. 2 is provided. This formulation provides for the use of ethylacetate solvent to balance the sprayability and dry to touch time of the formulation. With a controlled amount of film former and plasticizer to maintain the viscosity of the formulation the formulation is configured to maintain a sprayable consistency. Additionally, there can be an increased amount of release agent in order to provide for a more efficient peeling process. With the sprayed formula, a touch to dry time is achieved of 2 to 4 minutes at normal atmospheric conditions. Accordingly, the film can be configured to be peelable within 10 minutes, with a low stretchability in film while performing the peeling process.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims. Although the present invention has been described in terms of various embodiments, it is not intended that the invention be limited to these embodiments. Modification within the spirit of the invention will be apparent to those skilled in the art.

What is claimed is:

1. A process for protecting a surface of a substrate comprising:
a composition which uses bio-based, biodegradable film formers to provide a durable strippable coating, wherein the coating comprises of:
a film former configured to form a continuous film on the substrate;
a solvent, wherein the solvent is configured to result an easy application of the substance on the substrate;
one or more additives comprising: a plasticizer to improve flexibility of the film; a release agent configured to reduce adhesion of the substance coating the substrate; and
a thickener configured for adjusting a viscosity and a continuous dispersion of the substance.

2. The process of claim 1, wherein the film formers are selected from one or more of biodegradable film formers comprising poly vinyl alcohol, hydroxy propyl methylcellulose, cellulose acetate butyrate, ethyl cellulose, natural rubber latex.

3. The process of claim 1, wherein the solvent is selected from a list of non-toxic solvents comprising water, alcohols, acetone, glycol esters, glycol ethers and esters.

4. The process of claim 3, wherein the non-toxic solvents are configured to evaporate resulting in fast drying and a forming of a film wherein, a dry to touch time of the coating is less than 5 minutes.

5. The process of claim 1, wherein the plasticizer is selected from a group of one or more sucrose acetate butyrate, propylene glycol, glycerin, glycerol, dioctyladipate, diisononylphthalate, and epoxidized soybean oil.

6. The process of claim 1, wherein the release agents are selected from a group of one or more of non-ionic surfactants, fluoro-surfactants, siloxane-based surfactants, fatty diketene, wax emulsion, and soylecithin.

7. The process of claim 1, wherein the thickener is selected from a group of one or more of fumed silica, xanthan gum, and polysaccharides.

8. The process of claim 1, where in the coating can be applied on following substrate is one or more of metal, wood, plastic, or stone.

9. The process of claim 1, wherein the film former comprises of cellulose acetate butyrate, wherein a Hydroxyl content of the cellulose acetate butyrate is selected from the range of 1% to 5%.

10. The process of claim 1, wherein the plasticizer comprises of dioctyladipate.

11. The process of claim 1, wherein the plasticizer comprises of diisononylphthalate.

12. The process of claim 1, wherein the plasticizer comprises of sucrose acetate isobutyrate.

13. The process of claim 1, wherein the solvent comprises of Ethyl Alcohol, Isopropyl Alcohol, Acetone, Ethyl Acetate, and Butyl Acetate.

14. The process of claim 1, wherein the one or more additives comprises of polyether modified siloxane.

15. The process of claim 1, wherein the film former comprises of 8 to 20 weight % cellulose acetate butyrate.

16. The process of claim 1, wherein the plasticizer comprises of:
5 to 12 weight % of diocytladipate;
5 to 12 weight % of diisonoylphtalate; and
5 to 12 weight % of sucrose acetate isobutyrate.

17. The process of claim 1, wherein the solvent comprises of:
60 to 80 weight % of ethyl alcohol;
60 to 80 weight % of isopropyl alcohol;
60 to 80 weight percent of acetone;
60 to 80 weight percent of ethyl acetate; and
60 to 80 weight percent of butyl acetate.

18. The process of claim 1, wherein the one or more additives comprises of 0.5 to 5 percent of modified siloxane.
